(19) United States
(12) Patent Application Publication
(10) Pub. No.: US 2023/0389565 A1
(43) Pub. Date: Dec. 7, 2023

(54) SHELF-STABLE LIQUID COFFEE ADDITIVE

(71) Applicant: The Folger Coffee Company, Orrville, OH (US)

(72) Inventors: Joann Maxwell, Wadsworth, OH (US); Donald Lee Hughes, Akron, OH (US); Lindsay Michelle Crano, Medina, OH (US)

(73) Assignee: The Folger Coffee Company, Orrville, OH (US)

(21) Appl. No.: 18/206,510

(22) Filed: Jun. 6, 2023

Related U.S. Application Data
(60) Provisional application No. 63/349,791, filed on Jun. 7, 2022.

(51) Int. Cl. A23F 5/46; A23C 9/156; A23C 9/152; A23L 29/30; A23L 29/10

(52) U.S. Cl. CPC A23F 5/465; A23C 9/156; A23C 9/1528; A23L 29/30; A23L 29/10

(57) ABSTRACT

A shelf stable liquid composition for sweetening, flavoring, and lightening coffee, comprises a sweetener system, a dairy-based lightener system, flavor, water, shortening, and a second emulsifier component. The ingredients are cooked to form a liquid composition that is shelf stable for at least three months at room temperature.

### CROSS-REFERENCE TO RELATED APPLICATIONS

This application claims priority to and all benefit of U.S. Provisional Patent Application No. 63/349,791, filed on Jun. 7, 2022, the entire disclosure of which is fully incorporated herein by reference.

### BACKGROUND

Bitterness is often undesirable in the food and beverage industry. Bitter blocking or masking compounds or ingredients are often added to reduce the bitter taste in food and beverage products to make the product more palatable to the consumer. For example, coffee and similar beverages may exhibit bitter, ashy, burnt, woody and/or papery notes.

Creamers are well known in the art, and are available in dry powder or liquid form for addition to coffee or similar beverages to mask undesired flavor attributes. Additionally or alternatively, sweeteners and flavors, alone or in various combinations, may be added to coffee or similar beverages to mask undesired flavor attributes. However, creamers that include dairy-based ingredients often require refrigeration to prevent spoilage.

Accordingly, there remains a need for dairy-based coffee additives that are stable at room temperature.

### BRIEF SUMMARY

Various embodiments described herein are directed to a shelf stable liquid composition for sweetening, flavoring, and lightening coffee. The liquid composition comprises a sweetener system; a dairy-based lightener system; flavor; water; shortening; and a second emulsifier component. The ingredients are cooked to form a liquid composition that is shelf stable for at least three months at room temperature.

Additionally, various embodiments described herein are directed to a shelf stable liquid composition for sweetening, flavoring, and lightening coffee, comprising 50-60% sugars; 9-13% dairy powder; 10-11% shortening; flavor; water; and a second emulsifier component. The ingredients are cooked to form a liquid composition with 15-20% moisture and having a pH of 6.0-6.5 that is shelf stable for at least three months at room temperature.

In still further embodiments, a shelf stable liquid composition for sweetening, flavoring, and lightening coffee comprises 50-60% sugars; 6-10% cocoa/chocolate; 5-6% dairy powder; about 7% shortening; at least one polyol; flavor; water; and a second emulsifier component. The ingredients are cooked to form a liquid composition with 15-20% moisture and having a pH of 6.0-6.5 that is shelf stable for at least three months at room temperature.

According to various embodiments, a process for preparing a shelf stable liquid composition comprises heating a liquid sweetener; adding to the heated liquid sweetener a slurry comprising water, a dairy-based lightener system, shortening, and a second emulsifier component; adding to the heated liquid sweetener and slurry a granulated sweetener to form a mixture; cooking the mixture to a predetermined ° Brix at a temperature of about 215° F.; adding a flavor to the mixture after cooking; and homogenizing the mixture including the flavor, thereby forming the shelf stable liquid composition.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The general inventive concepts encompass shelf-stable liquid compositions for sweetening, flavoring, and lightening coffee. In various embodiments presented herein, the liquid compositions include a sweetener system, a dairy-based lightener system, flavor, water, shortening, and a second emulsifier component. Notwithstanding the presence of the dairy-based lightener system, the liquid compositions are stable at room temperature and do not require refrigeration.

Unless otherwise defined, all technical and scientific terms used herein have the same meaning as commonly understood by one of ordinary skill in the art to which the present disclosure belongs. The terminology used in the description of this disclosure is for describing particular embodiments only and is not intended to be limiting of the concepts described herein. As used in the description and the appended claims, the singular forms “a,” “an,” and “the” are intended to include the plural forms as well, unless the context clearly indicates otherwise. All publications, patent applications, patents, and other references mentioned herein are incorporated by reference in their entireties as though they are fully set forth herein.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that can vary depending on the desired properties sought to be obtained in various embodiments described herein. Notwithstanding that the numerical ranges and parameters setting for the broad scope of the embodiments are approximations; the numerical values set forth in the specific examples are reported with relative precision. Any numerical values, however, inherently contain certain errors necessarily resulting from error found in their respective measurements.

As used herein, the phrase “stable” or “shelf-stable” means that the product can withstand prolonged storage without refrigeration without spoiling. Indications of spoilage include, but are not limited to, development of “off-flavors,” odors, color change, separation of phases, or development of characteristics that are undesirable to consumers. In some embodiments, spoilage can refer to greater than 10 colony-forming units of microbes present per gram of sample, where the microbes measured include aerobic microbes, coliform, Escherichia coli (E. coli), yeast and mold (Y/M) or combinations thereof.

Various embodiments provide a shelf-stable, liquid composition for sweetening, flavoring, and lightening coffee. The liquid composition includes a sweetener system, a dairy-based lightener system, flavor, water, shortening, and a second emulsifier component. In various embodiments, the liquid composition is stable under ambient shelf conditions for at least three (3) months. That is, the quality of the liquid composition is stable for a period of at least 3 months at a temperature of from about 20° C. to about 25° C. In some embodiments, the liquid composition is stable for at least six (6) months, at least nine (9) months, at least twelve (12) months, at least eighteen (18) months, or at least twenty-four (24) months. For example, the liquid composition can be stable for a period of from 3 months to 36 months, from 3 months to 30 months, from 3 months to 24 months, from 3 months to 18 months, from 6 months to 36 months, from 6 months to 30 months, from 6 months to 24 months, from 6 months to 18 months, from 9 months to 36 months, from 9 months to 30 months, from 9 months to 24 months, from 9 months to 18 months, from 12 months to 36 months, from 12 months to 30 months, from 12 months to 24 months, or from 12 months to 18 months. Some embodiments of the liquid composition can be stable for longer than 36 months, depending on exact composition and the storage conditions.

A sweetener system includes one or more sweeteners. Sweeteners can include non-caloric (low-caloric) and caloric sweeteners that impart a wide range of sweetness to the liquid composition. Sweeteners suitable for use include, but are not limited to, sugars such as cane sugar, sucrose, fructose, dextrose, lactose, and maltose; polysaccharide-based sweeteners such as corn syrup, maltodextrin, and polydextrose; molasses; polyols such as glycerin and sorbitol; high-intensity sweeteners such as saccharin, cyclamates, acesulfame, sucralose, and L-aspartyl based sweeteners such as aspartame; and mixtures of these sweeteners. Corn syrup includes but is not limited to high fructose corn syrup and/or high maltose corn syrup. The sweeteners used with the liquid compositions may be in liquid or granulated form. Nonlimiting specific examples of granulated sweeteners include granulated sugar cane and granulated sucrose. Nonlimiting examples of liquid sweeteners include liquid fructose, high fructose corn syrup, high maltose corn syrup, and molasses. Other sweeteners can be added depending on the particular embodiment. For example, in some embodiments, the liquid composition includes a sweetener system including a liquid sweetener and a granulated sweetener, such as a liquid fructose or high maltose corn syrup (a liquid) and a granulated cane sugar or granulated sucrose. The combination of a liquid sweetener and a granulated sweetener can provide synergy to obtain a suitable mouthfeel, sweetness, and flavor profile. For example, the liquid sweetener can enable the formation of a super saturated sweetening system that has an increased sugar content as compared to sweetener systems including granulated sweetener alone. This super saturated sweetener system can have an osmotic effect on the liquid composition and may provide some level of antimicrobial protection.

The sweetener system is present in the liquid composition in a total amount of from about 40.0 wt. % to about 85.0 wt. %, from about 45.0 wt. % to about 82.5 wt. %, from about 50.0 wt. % to about 80.0 wt. %, from about 50.0 wt. % to about 60 wt. %, or from about 55.0 wt. % to about 77.5 wt. %, based on a total weight of the liquid composition. When included, corn syrup (e.g., high maltose corn syrup or high fructose corn syrup) can be included in amount of from about 2.5 wt. % to about 10.0 wt. %, from about 3.0 wt. % to about 9.75 wt. %, or from about 3.0 wt. % to about 5 wt. %, based on a total weight of the liquid composition. In embodiments, liquid fructose is present in an amount of from about 10.0 wt. % to about 50 wt. %, from about 10 wt. % to about 15.0 wt. %, from about 25 wt. % to about 50 wt. %, from about 30 wt. % to about 47.5 wt. %, or from about 35.0 wt. % to about 45.0 wt. %, based on a total weight of the liquid composition. In some embodiments, sugar, including granulated sugar (e.g., granulated cane sugar or granulated sucrose) is present in an amount of from about 15 wt. % to about 50 wt. %, from about 20 wt. % to about 45 wt. %, from about 20 wt. % to about 25 wt. %, or from about 35 wt. % to about 45 wt. %, based on a total weight of the liquid composition. In various embodiments, molasses is included in an amount of from about 1.0 wt. % to about 3 wt. %, or from about 1.5 wt. % to about 2.5 wt. %.

In some particular embodiments, the liquid composition includes greater than about 35 wt. % liquid fructose and less than about 25 wt. % granulated sugar. For example, the liquid composition can include from about from about 35.0 wt. % to about 45.0 wt. % liquid fructose and from about 20 wt. % to about 25 wt. % granulated sugar. In other embodiments, the liquid composition includes less than about 15 wt. % liquid fructose and greater than about 35 wt. % granulated sugar. For example, the liquid composition can include from about from about 35.0 wt. % to about 45.0 wt. % liquid fructose and from about 20 wt. % to about 25 wt. % granulated sugar.

In some embodiments, the liquid composition includes a total amount of from about 50 wt. % to about 60 wt. % sweetener system based on a total weight of the liquid composition, including from about 4 wt. % to about 10 wt. % high maltose corn syrup, from about 38 wt. % to about 43 wt. % liquid fructose, and from about 21 wt. % to about 23 wt. % granulated cane sugar, based on a total weight of the sweetener system. In some embodiments, the liquid composition includes a total amount of from about 50 wt. % to about 60 wt. % sweetener system based on a total weight of the liquid composition, including about 3 wt. % high maltose corn syrup, from about 11 wt. % to about 13 wt. % liquid fructose, and from about 40 wt. % to about 43 wt. % granulated cane sugar, based on a total weight of the sweetener system. In some embodiments, when included, glycerin can be included in the liquid composition in an amount of up to 5 wt. %, such as from about 1.0 wt. % to about 5.0 wt. %, from about 2.0 wt. % to about 4.0 wt. %, or from about 2.5 wt. % to about 3.5 wt. %, based on a total weight of the liquid composition.

A dairy-based lightener system, also referred to herein as milk solids, is also included in the liquid composition. The dairy-based lightener system can be provided in the form of a powdered milk or a suitable milk concentrate. In various embodiments, the dairy-based lightener system includes from about 5 wt. % to about 13 wt. % dairy solids. The dairy-based lightener system can include, by way of example and not limitation, whole milk powder, low-fat milk powder, non-fat milk powder, cream powder (e.g., dried sweet cream powder), and combinations thereof. The dairy-based lightener system is present in the liquid composition in an amount of from about 5 wt. % to about 20 wt. %, or from about 5 wt. % to about 15 wt. %, based on a total weight of the liquid composition. In some embodiments, the liquid composition includes from about 9 wt. % to about 13 wt. % powdered milk (sometimes referred to as “dairy powder”), or from about 5 wt. % to about 6 wt. % powdered milk.

In various embodiments, the liquid composition further includes water. The water can be included as a solvent and can be used to adjust a viscosity and final concentration of the liquid composition. Alternatively or in addition, the water may be introduced as part of another ingredient, e.g., water may be present as the liquid phase of liquid fructose. In embodiments, the water is present in the liquid composition in an amount of from about 3.0 wt. % to about 20.0 wt. %, such as from about 3.5 wt. % to about 10.0 wt. %, from about 4.0 wt. % to about 7.5 wt. %, from about 4.0 wt. % to about 6.0 wt. %, from about 10.0 wt. % to about 20.0 wt. %, or from about 12.5 wt. % to about 17.5 wt. %, based on a total weight of the liquid composition.

Shortening is included in various embodiments as an emulsifier to provide a smooth texture to the liquid composition while retaining the moisture content and keeping the liquid composition stable, e.g., helping keep components from separating. Shortening also helps to absorb the sweetener in the liquid composition and reduce the surface tension of the liquid composition to maintain fat globules in suspension, and can provide certain elements of flavor to the composition. In various embodiments, the shortening is a vegetable shortening, such as hydrogenated or non-hydrogenated soy shortening, cottonseed shortening, palm shortening, or combinations thereof. Other shortenings known and used in the food and beverage industry can additionally or alternatively be included. The shortening can be included in the liquid composition in an amount of from about 5 wt. % to about 13 wt. %, based on a total weight of the liquid composition. For example, the liquid composition can include from about 5 wt. % to about 13 wt. %, from about 5 wt. % to about 12 wt. %, from about 5 wt. % to about 11 wt. %, from about 5 wt. % to about 10 wt. %, from about 5 wt. % to about 9 wt. %, from about 5 wt. % to about 8 wt. %, from about 6 wt. % to about 13 wt. %, from about 6 wt. % to about 12 wt. %, from about 6 wt. % to about 11 wt. %, from about 6 wt. % to about 10 wt. %, from about 6 wt. % to about 9 wt. %, from about 6 wt. % to about 8 wt. %, from about 7 wt. % to about 8 wt. %, from about 7 wt. % to about 9 wt. %, from about 7 wt. % to about 10 wt. %, from about 8 wt. % to about 9 wt. %, from about 8 wt. % to about 10 wt. %, from about 8 wt. % to about 11 wt. %, from about 9 wt. % to about 10 wt. %, from about 9 wt. % to about 11 wt. %, or from about 10 wt. % to about 11 wt. % based on a total weight of the liquid composition.

In addition to the shortening, the liquid composition of various embodiments includes at least one additional emulsifier to aid in the dispersion of the various ingredients in the liquid composition and to enhance stability of the liquid composition. This additional emulsifier is referred to herein as the “second emulsifier component.” Emulsifiers suitable for use as the second emulsifier component include, but are not limited to, lecithin, hydroxylated lecithin, soy lecithin, mono, di, or polyglycerides of fatty acids, polyoxyethylene ethers of fatty esters of polyhydric alcohols, fatty esters of polyhydric alcohols, polyglycerol esters of mono and di glycerides such as hexaglyceryl distearate, mono- and diesters of glycols, and mixtures thereof. The second emulsifier component can be included in the liquid composition in an amount of less than about 0.2 wt. %, including from about 0.05 wt. % to about 0.2 wt. %, from about 0.10 wt. % to about 0.2 wt. %, or from about 0.15 wt. % to about 0.2 wt. %, based on a total weight of the liquid composition.

One or more additives can optionally be added to embodiments of the liquid composition. Examples of such additives include, but are not limited to, buffers such as sodium and potassium bicarbonate, di-sodium and di-potassium phosphate, sodium and potassium citrates, and various combinations of these buffers; natural or artificial colorings; salt; anti-foam agents including mono- and di-glyceride agents; preservatives such as potassium sorbate; and the like. Other additives can be used depending on the particular embodiment. When present, the additives can be included in the liquid composition in an amount of less than or equal to about 0.2 wt. % each, based on a total weight of the liquid composition.

Flavors (sometimes referred to herein as “flavorants”) impart flavor to the liquid composition. Flavors suitable for use in the liquid composition include natural or non-natural (synthetic or artificial) flavors. Flavorants include, by way of example and not limitation, cocoa powder (alkalized, non-alkalized, and combinations thereof), chocolate liquor, mocha flavor, caramel flavor, hazelnut flavor, French vanilla flavor, peppermint flavor, chocolate flavor, pumpkin spice flavor, and combinations thereof. The flavors can be added as a pre-prepared flavor, or as a combination of one or more flavorants suitable to mix within the liquid composition to impart a particular final flavor. For example, ethyl vanillin, acetoin, acetylpropionyl, furaneol, acetylbutyryl, butyric acid, dipentene, vanillin, 3-methylbutanal, 2-methylpropanal, propionic acid, methanoic acid, phenylmethanol, ethyl maltol, menthol, methone, isomenthone, and other flavoring agents can be used in various combinations to achieve a particular final flavor of the liquid composition. In embodiments, the flavor agents are dispersed in a carrier (e.g., propylene glycol) prior to addition to the liquid composition.

The flavor can be added to the liquid composition in an amount of from about 0.1 wt. % to about 5 wt. % each, based on a total weight of the liquid composition. The amount of flavor added can vary depending on the embodiment, particularly, depending on the particular flavor to be added and the desired final flavor of the liquid composition. In some embodiments, when chocolate liquor is added as a wafer, it is added in an amount of from about 2.0 wt. % to about 3.0 wt. % based on a total weight of the liquid composition. When cocoa powder is included in the liquid composition, it can be added in an amount of from about 3.0 wt. % to about 8.0 wt. %, based on a total weight of the liquid composition. Some embodiments include from about 3.0 wt. % to about 4.0 wt. % of alkalized cocoa powder and from about 3.0 wt. % to about 4.0 wt. % non-alkalized (e.g., natural) cocoa powder. Other flavors can be added in an amount of from about 0.1 wt. % to about 4 wt. %, such as from about 0.1 wt. % to about 3.5 wt. %, from about 0.1 wt. % to about 3 wt. %, from about 0.1 wt. % to about 2.5 wt. %, from about 0.1 wt. % to about 2.0 wt. %, from about 0.1 wt. % to about 1.5 wt. %, from about 0.1 wt. % to about 1.0 wt. %, from about 0.2 wt. % to about 0.9 wt. %, from about 0.5 wt. % to about 1.0 wt. %, or from about 0.1 wt. % to about 0.4 wt. %, based on a total weight of the liquid composition.

In various embodiments, the liquid composition does not contain (e.g., is free of or substantially free of) coffee aroma, or coffee, such as coffee concentrate and/or extract of roast coffee, and microparticulated whey protein. As used herein, “coffee aroma” refers to the volatile components of coffee that produce the characteristic fragrance of coffee, and may be provided in the form of a highly aromatized coffee concentrate or natural coffee aroma components that are collected during the preparation of soluble coffee powder. Microparticulated whey protein includes partially insoluble, partially denatured protein compositions prepared through controlled application of heat and high shear conditions to facilitate protein denaturation in a physical and chemical context. As used herein, “microparticulated” refers to particles having an average diameter of from about 0.1 microns to about 10 microns. In some embodiments, microparticulated whey protein may be included in the liquid composition. However, when present, the amount of microparticulated whey protein is less than the amount of dairy-based ingredients.

In some particular embodiments, the liquid composition includes 38.6-43% liquid fructose; 21-22% sugar; 10.2-10.6% shortening; 9.6-10.2% milk powder (28.5% milk fat); 4.6-9.6% corn syrup; 4-6% water; 1.8-2% molasses; 1.1-1.3% cream powder; 0.6-3% flavorants/ingredients to facilitate the flavorants, such as propylene glycol; and 0.2% or less of each of the following: buffering agent, such as disodium phosphate; salt; sodium citrate; soy lecithin; potassium sorbate preservative; and mono- and di-glyceride anti-foam agent.

In other particular embodiments, the liquid composition includes 42.3% sugar; 15.9% water; 11.1% liquid fructose; 7.6% shortening; 5.3% milk powder (non-fat); 3.5% cocoa powder (non-alkalized); 3.5% cocoa powder (alkalized); 3% corn syrup; 3.0% glycerin (99.7%); 2.5% chocolate liquor; <1% of flavorants/ingredients to facilitate the flavorants, such as propylene glycol; 0.55% cream powder; and 0.2% or less of each of the following: sodium citrate; salt; soy lecithin; potassium sorbate preservative; buffering agent, such as disodium phosphate; and mono- and di-glyceride anti-foam agent.

In some embodiments, the liquid composition has a viscosity of less than about 70,000 cps when measured at room temperature. For example, the liquid composition may have a viscosity of from about 2,000 cps to about 70,000 cps, from about 2,000 cps to about 50,000 cps, from about 2,000 cps to about 30,000 cps, from about 2,000 cps to about 20,000 cps, from about 2,000 cps to about 15,000 cps, or from about 2,000 cps to about 10,000 cps, including any and all ranges and subranges therein. In some embodiments, the liquid composition may have an initial viscosity of from about 2,000 cps to about 70,000 cps, from about 2,000 cps to about 50,000 cps, from about 2,000 cps to about 30,000 cps, from about 2,000 cps to about 20,000 cps, from about 2,000 cps to about 15,000 cps, or from about 2,000 cps to about 10,000 cps, including any and all ranges and subranges therein. As used herein, the phrase “initial viscosity” refers to the viscosity of the liquid composition following packaging and cooling to room temperature.

In some embodiments, the liquid composition may have a viscosity of from about 3,000 cps to about 70,000 cps, from about 3,000 cps to about 50,000 cps, from about 3,000 cps to about cps, from about 3,000 cps to about 20,000 cps, from about 3,000 cps to about 15,000 cps, from about 3,000 cps to about 10,000 cps, from about 10,000 cps to about 70,000 cps, from about cps to about 50,000 cps, from about 10,000 cps to about 40,000 cps, from about 9,000 cps to about 12,000 cps, from about 2,500 cps to about 3,500 cps, from about 8,000 cps to about 35,000 cps, or from about 25,000 cps to about 50,000 cps, including any and all ranges and subranges therein, when measured at room temperature after storage at 40° F. for 3 months. In some embodiments, the liquid composition may have a viscosity of from about 3,000 cps to about 70,000 cps, from about 3,000 cps to about 50,000 cps, from about 3,000 cps to about 30,000 cps, from about 3,000 cps to about 20,000 cps, from about 3,000 cps to about 15,000 cps, from about 3,000 cps to about 10,000 cps, from about 15,000 cps to about 70,000 cps, from about 15,000 cps to about 60,000 cps, from about 15,000 cps to about 55,000 cps, from about 9,000 cps to about 20,000 cps, from about 2,500 cps to about 5,000 cps, from about 8,000 cps to about 60,000 cps, from about 20,000 cps to about 60,000 cps, from about 25,000 cps to about 55,000 cps, or from about cps to about 60,000 cps, including any and all ranges and subranges therein, when measured at room temperature after storage at 90° F. for 3 months. Viscosity measurements referred to herein refer to a Brookfield viscosity measurement at room temperature. It should be appreciated that some liquid compositions may have a viscosity outside these ranges depending on the intended mode for dispensing the liquid composition.

The water activity of the liquid composition can provide protection against microbial growth in various embodiments. In particular, microorganisms rely on available water in the liquid composition for growth, and the ability of a microorganism to take up water depends on a water activity gradient. When water activity outside of a cell becomes low enough, the microorganisms may not be able to take up water and can become dormant and unable to grow and cause infection or spoilage. In various embodiments, the liquid composition has a water activity (aw) of less than or equal to about 0.85, less than or equal to about 0.84, less than or equal to about 0.83, less than or equal to about 0.82, less than or equal to about 0.81, less than or equal to about 0.80, less than or equal to about 0.79, less than or equal to about 0.78, less than or equal to about 0.77, less than or equal to about 0.76, or even less than or equal to about 0.75, including any and all ranges and subranges therein. In embodiments, the liquid composition has an aw of from 0.71 to 0.82, from to 0.81, from 0.71 to 0.80, from 0.71 to 0.79, from 0.71 to 0.78, from 0.71 to 0.77, from 0.71 to 0.76, from 0.71 to 0.75, 0.73 to 0.82, from 0.73 to 0.81, from 0.73 to 0.80, from 0.73 to 0.79, from 0.73 to 0.78, from 0.73 to 0.77, from 0.73 to 0.76, or from 0.73 to 0.75, including any and all ranges and subranges therein. In some embodiments, the initial aw of the liquid composition is from 0.73 to 0.80. In some embodiments, the aw of the liquid composition is from 0.74 to 0.77 after storage at 40° F. for 1 month. In some embodiments, the aw of the liquid composition is from to 0.78 after storage at 90° F. for 1 month. In some embodiments, the aw of the liquid composition is from 0.74 to 0.77 after storage at 40° F. for 3 months. In some embodiments, the aw of the liquid composition is from 0.75 to 0.78 after storage at 90° F. for 3 months. The aw is the ratio between the vapor pressure of the liquid composition when in an undisturbed balance with the surrounding air media and the vapor pressure of distilled water under identical conditions. All aw values reported herein are measured at room temperature.

In various embodiments has a moisture of from about 15% to about 20%. For example, the liquid composition can have a moisture content of from about 15.0% to about 20.0%, from about 15.0% to about 19.5%, from about 15.0% to about 19.0%, from about 15.0% to about 18.5%, from about 15.0% to about 18.0%, from about 15.0% to about 17.5%, from about 15.0% to about 17.0%, from about 15.0% to about 16.5%, from about 15.5% to about 20.0%, from about 15.5% to about 19.5%, from about 15.5% to about 19.0%, from about 15.5% to about 18.5%, from about to about 18.0%, from about 15.5% to about 17.5%, from about 15.5% to about 17.0%, from about 15.5% to about 16.5%, from about 16.0% to about 20.0%, from about 16.0% to about 19.5%, from about 16.0% to about 19.0%, from about 16.0% to about 18.5%, from about 16.0% to about 18.0%, from about 16.0% to about 17.5%, from about 16.0% to about 17.0%, or even from about 16.0% to about 16.5%, including any and all ranges and subranges therein. In some embodiments, the liquid composition has an initial moisture content of from about 15.0% to about 19.5%. In some embodiments, the liquid composition has a moisture content of from about 16.5% to about 19.5% when measured at room temperature after storage at 40° F. for 1 month. In some embodiments, the liquid composition has a moisture content of from about 16.5% to about 20.0% when measured at room temperature after storage at 90° F. for 1 month. In some embodiments, the liquid composition has a moisture content of from about 15.0% to about 18.5% when measured at room temperature after storage at 40° F. for 3 months. In some embodiments, the liquid composition has a moisture content of from about 16.0% to about 17.5% when measured at room temperature after storage at 90° F. for 3 months. All moisture content measurements herein are measured at room temperature.

According to various embodiments, the liquid composition has a pH of from 5 to about 8, from about 5.5 to about 7.0, or from about 6.0 to about 6.5. For example, the liquid composition can have a pH of from about 5.0 to about 8.0, from about 5.0 to about 7.5, from about 5.0 to about 7.0, from about 5.0 to about 6.5, from about 5.5 to about 8.0, from about 5.5 to about 7.5, from about 5.5 to about 7.0, from about 5.5 to about 6.5, from about 6.0 to about 8.0, from about 6.0 to about 7.5, from about 6.0 to about 7.0, or from about 6.0 to about 6.5, including any and all ranges and subranges therein. In some embodiments, the liquid composition has an initial pH of from about 5.5 to about 6.5, or from about 5.75 to about 6.25.

The liquid composition of various embodiments is further stable under ambient shelf storage conditions for at least about 3 months. That is, the quality of the liquid composition is stable for a period of at least 3 months at a temperature of from about 20° C. to about 25° C. However, as described hereinabove, in some embodiments, the liquid composition can be stable for at least 6 months, at least 9 months, at least 12 months, at least 18 months, or longer. In some embodiments, the liquid composition exhibits less than or equal to 10 cfu/g of coliform on a PETRIFILM CC plate after 1 month. In some embodiments, the liquid composition exhibits less than or equal to 10 cfu/g of E. coli and coliforms on a PETRIFILM ECC plate after 1 month. In some embodiments, the liquid composition exhibits less than or equal to 10 cfu/g of yeast and mold on a PETRIFILM Y/M plate after 1 month. In some embodiments, the liquid composition exhibits less than or equal to 10 cfu/g of coliform on a PETRIFILM CC plate after 3 months. In some embodiments, the liquid composition exhibits less than or equal to 10 cfu/g of E. coli and coliforms on a PETRIFILM ECC plate after 3 months. In some embodiments, the liquid composition exhibits less than or equal to 10 cfu/g of yeast and mold on a PETRIFILM Y/M plate after 3 months. In some embodiments, the liquid composition exhibits less than or equal to 10 cfu/g of coliform on a PETRIFILM CC plate after 6 months. In some embodiments, the liquid composition exhibits less than or equal to 10 cfu/g of E. coli and coliforms on a PETRIFILM ECC plate after 6 months. In some embodiments, the liquid composition exhibits less than or equal to cfu/g of yeast and mold on a PETRIFILM Y/M plate after 6 months. In some embodiments, the liquid composition exhibits less than or equal to 10 cfu/g of coliform on a PETRIFILM CC plate after 9 months. In some embodiments, the liquid composition exhibits less than or equal to 10 cfu/g of E. coli and coliforms on a PETRIFILM ECC plate after 9 months. In some embodiments, the liquid composition exhibits less than or equal to 10 cfu/g of yeast and mold on a PETRIFILM Y/M plate after 9 months. In some embodiments, the liquid composition exhibits less than or equal to 10 cfu/g of coliform on a PETRIFILM CC plate after 12 months. In some embodiments, the liquid composition exhibits less than or equal to 10 cfu/g of E. coli and coliforms on a PETRIFILM ECC plate after 12 months. In some embodiments, the liquid composition exhibits less than or equal to 10 cfu/g of yeast and mold on a PETRIFILM Y/M plate after 12 months. PETRIFILM plates are commercially available from 3M, and samples are prepared in accordance with the manufacturer's instructions.

In various embodiments, the liquid composition is prepared by adding the ingredients to a mix kettle to form a mixture and heating the mixture for a time of greater than about 2 minutes. In some particular embodiments, any corn syrup and/or liquid fructose is added first to the mix kettle, followed by anti-foam agents and a slurry. The slurry is prepared by combining the ingredients of the liquid composition except for the sweetener system, the flavor, and the anti-foam agent (e.g., the water, the dairy-based lightener, the shortening, and the second emulsifier component). Finally, the granulated sweetener (e.g., granulated cane sugar or granulated sucrose) is added to the mix kettle. The mixture is heated to a temperature of from about 100° F. to about 150° F.

After heating, the mixture is transferred from the mix kettle to a vacuum cooker, which is agitated, de-aerated, and heated to a temperature of about 215° F., or until the mixture is boiling, to cook the mixture to the desired ° Brix and evaporate at least a portion of the water. The mixture is then cooled to a temperature of from about 170° F. to about 185° F. The mixture is then transferred to a standardizing pan that is maintained at a temperature of from about 170° F. to about 185° F. Flavor is added and then the mixture is agitated for about 5 minutes before being homogenized and transferred to a filler. The mixture is transferred from the filler to a pasteurizer where it is pasteurized before being cooled and packaged. In various embodiments, the package is filled hot and then pasteurized, but the package itself is not sterilized. The packaging itself is not particularly limited, and can include polypropylene and/or ethylene-vinyl alcohol (EVOH) films and laminates, as well as other materials conventionally used in food packaging applications.

Although the process may vary from the process described hereinabove, in various embodiments, the liquid composition is not subjected to colloidal milling during processing.

In various embodiments, the ° Brix of the mixture is measured at various points during the manufacturing process to ensure that the resulting liquid composition has the desired solids content and flavor. For example, in some embodiments, the ° Brix is measured upon entry of the mixture into the vacuum cooker, upon discharge of the mixture from the vacuum cooker, in the standardizing pan, and in the filler. In various embodiments, the ° Brix of the liquid composition upon discharge from the vacuum cooker is from about 70° Brix to about 73° Brix. However, it is contemplated that the ° Brix may vary depending on the particular embodiment.

### EXAMPLES

Six exemplary liquid compositions prepared according to the embodiments described herein are presented in Table 1 below.

| | | | | | Peppermint | Pumpkin |
|---|---|---|---|---|---|---|
| | Mocha | Caramel | Hazelnut | Vanilla | Mocha | Spice |
| Ingredients | w/w % | w/w % | w/w % | w/w % | w/w % | w/w % |
| CORN SYRUP IX HIGH | 3.02% | 9.56% | 4.72% | 4.65% | 2.98% | 9.91% |
| MALTOSE | | | | | | |
| FRUCTOSE LIQUID | 11.09% | 38.67% | 42.93% | 42.27% | 12.22% | 40.08% |
| SUGAR CANE GRANULAR | 42.34% | 21.98% | 21.72% | 21.39% | 40.69% | 22.79% |
| SHORTENING SOY | 7.56% | 10.51% | 10.39% | 10.23% | 7.44% | 10.9% |
| COTTONSEED | | | | | | |
| ANTIFOAM | 0.05% | 0.05% | 0.05% | 0.05% | 0.03% | 0.03% |
| WATER | 15.85% | 4.19% | 5.88% | 5.07% | 17.12% | 0.99% |
| DISODIUM PHOSPHATE | 0.15% | 0.16% | 0.16% | 0.15% | 0.15% | 0.17% |
| ANHYDROUS GRANULAR | | | | | | |
| SODIUM CITRATE FINE | 0.2% | 0.14% | 0.14% | 0.14% | 0.2% | 0.15% |
| GRANULAR | | | | | | |
| MILK WHOLE POWDER | N/A | 10.16% | 9.79% | 9.65% | N/A | 10.53% |
| 28.5% FAT LOW HEAT | | | | | | |
| SALT | 0.11% | 0.14% | 0.14% | 0.14% | 0.11% | 0.15% |
| DRIED SWEET CREAM | 0.55% | 1.24% | 1.2% | 1.18% | 0.55% | 1.29% |
| SOY LECITHIN | 0.2% | 0.19% | 0.18% | 0.18% | 0.2% | 0.2% |
| POTASSIUM SORBATE | 0.2% | 0.19% | 0.18% | 0.18% | 0.2% | 0.2% |
| GRANULAR | | | | | | |
| MOLASSES | N/A | 1.91% | 1.84% | 1.82% | N/A | 1.98% |
| CHOCOLATE LIQUOR | 2.52% | N/A | N/A | N/A | 2.48% | N/A |
| WAFER | | | | | | |
| COCOA NATURAL | 3.53% | N/A | N/A | N/A | 3.47% | N/A |
| POWDER | | | | | | |
| COCOA ALKALIZED | 3.53% | N/A | N/A | N/A | 3.47% | N/A |
| POWDER | | | | | | |
| MILK DRY NON FAT HIGH | 5.29% | N/A | N/A | N/A | 5.21% | N/A |
| HEAT | | | | | | |
| GLYCERIN USP 99.7% | 3.02% | N/A | N/A | N/A | 2.98% | N/A |
| FFS MOCHA FLAVOR N&A | 0.76% | N/A | N/A | N/A | N/A | N/A |
| 236G89 | | | | | | |
| Firmenich CARAMEL | N/A | 0.89% | N/A | N/A | N/A | N/A |
| FLAVOR N&A 514996T | | | | | | |
| Firmenich HAZELNUT | N/A | N/A | 0.67% | N/A | N/A | N/A |
| FLAVOR N&A C28005 | | | | | | |
| FFS FRENCH VANILLA | N/A | N/A | N/A | 2.91% | N/A | N/A |
| FLAVOR TYPE N&A 236F47 | | | | | | |
| Firmenich NATURAL | N/A | N/A | N/A | N/A | 0.3% | N/A |
| PEPPERMINT 539956 6T | | | | | | |
| Firmenich N&A Chocolate | N/A | N/A | N/A | N/A | 0.21% | N/A |
| Flavor 599153 SII | | | | | | |
| FFS N&A Pumpkin Spice | N/A | N/A | N/A | N/A | N/A | 0.66% |
| Flavor 236Z05 | | | | | | |
| | 100% | 100% | 100% | 100% | 100% | 100% |

To prepare the liquid compositions, a slurry was prepared by adding to water a portion of the antifoam, soy lecithin, disodium phosphate, potassium sorbate, sodium citrate, and salt along with the molasses (for the caramel, hazelnut, vanilla, and pumpkin spice compositions) or glycerin (for the mocha and peppermint mocha compositions). The dried sweet cream was added with the whole milk powder (for the caramel, hazelnut, vanilla, and pumpkin spice compositions) or non-fat dry milk and cocoa (for the mocha and peppermint mocha compositions) and the slurry was mixed to ensure a substantially uniform slurry.

Next, the remaining antifoam was mixed with the high maltose corn syrup and the shortening was melted and added to the mixture. For the mocha and peppermint mocha compositions, the chocolate liquor wafer was melted with the shortening. Once mixed, the slurry was added to the shortening mixture, followed by the fructose liquid and the granular sugar. The ingredients were mixed to ensure that the sugar was dissolved and the mixture was uniform.

The mixture was then heated to a temperature of from about 210° F. to about 215° F., where it began to boil. Upon reaching the boiling point, the heat was decreased and a vacuum was applied to reach 175° F. Mixing continued and water in the mixture was evaporated to achieve approximately 73° Brix (70° Brix for the mocha composition). Next, the flavors were added and mixed to ensure uniformity of each of the compositions.

Following addition of the flavors, the mixture was homogenized, filtered, and packaged into polypropylene bottles at a temperature of between about 165° F. and 180° F. The filled and sealed packages were pasteurized at about 180° F. for about 35 minutes followed by cooling to a temperature of less than 90° F.

Various physical properties of the caramel, vanilla, and mocha compositions, including brix, pH, water activity, density, moisture % and viscosity were measured at an initial interval (prior to entering controlled temperature rooms) as well as at month 1 and month 3 where samples were stored in controlled temperature rooms at 40° F. or 90° F. The properties are presented in Table 2 below.

TABLE 2

| | Caramel | | Vanilla | | Mocha | |
|---|---|---|---|---|---|---|
| CT Room Temp. | 40° F. | 90° F. | 40° F. | 90° F. | 40° F. | 90° F. |

Brix (°brix)

| Initial | | 71.5 | | 73.9 | | 73.2 | |
|---|---|---|---|---|---|---|---|
| 1 | month | 73.1 | 72.7 | 73.8 | 73.7 | 73.2 | 73.0 |
| 3 | months | 72.9 | 73.0 | 73.9 | 73.8 | 73.4 | 73.2 |

pH

| Initial | | 6.0 | | 6.0 | | 6.1 | |
|---|---|---|---|---|---|---|---|
| 1 | month | 6.1 | 6.0 | 6.0 | 6.1 | 6.1 | 6.1 |
| 3 | months | 6.0 | 5.9 | 5.9 | 5.8 | 6.1 | 6.0 |

Water Activity (a_{w})

| Initial | | 0.79 | | 0.75 | | 0.79 | |
|---|---|---|---|---|---|---|---|
| 1 | month | 0.76 | 0.76 | 0.74 | 0.76 | 0.77 | 0.77 |
| 3 | months | 0.76 | 0.77 | 0.76 | 0.75 | 0.77 | 0.78 |

Density (g/cc)

| Initial | | 1.27 | | 1.29 | | 1.29 | |
|---|---|---|---|---|---|---|---|
| 1 | month | 1.29 | 1.29 | 1.29 | 1.29 | 1.29 | 1.28 |
| 3 | months | 1.29 | 1.28 | 1.28 | 1.28 | 1.29 | 1.28 |

Moisture (%)

| Initial | | 19.4 | | 17.0 | | 15.2 | |
|---|---|---|---|---|---|---|---|
| 1 | month | 18.1 | 17.9 | 16.8 | 18.5 | 19.4 | 19.7 |
| 3 | months | 18.3 | 17.1 | 17.9 | 17.4 | 14.5 | 16.3 |

Viscosity (cps)

| Initial | | 9,000 | | 2,500 | | 26,400 | |
|---|---|---|---|---|---|---|---|
| 1 | month | 11,000 | 9,800 | 2,800 | 2,800 | 35,500 | 45,500 |
| 3 | months | 11,500 | 19,500 | 3,300 | 4,000 | 46,400 | 53,200 |

Brix was measured on a Rudolph J-157 refractometer at 20° C. using a sapphire J series prism and SMART MEASURE software to provide a refractive index for each of the samples and brix tables to convert the refractive index to ° brix at 20° C. The pH was measured at room temperature using a FISHERBRAND ACCUMET AB15 meter calibrated with buffers of pH 4 and 7 and a slope reading between 96 and 102.0.

Water activity was measured on an AquaLab 4TE/4TEV equipped with a Rotronic HygroLab 3 water activity meter. Density was measured using a Gardner Standard silver density cup in accordance with methods known and used in the art.

Viscosity was measured on a HAT Brookfield viscometer using the dial viscometer methodology. All samples were measured at room temperature in centipoise. In particular, the viscometer was leveled and the speed on the side of the dial unit was set to the desired rpm. The spindle was attached and immersed in the test material by turning the dial until the sample was level with the groove cut in the spindle shaft. The viscometer motor was turned on and three rotations of the dial were allowed before a reading was taken. If the reading was above 100, the spindle number was increased or the rpms were decreased. If the reading was below 10, the spindle number was decreased or the rpms were increased. If the spindle number or rpms were changed, the process was repeated until the reading was between 10 and 100. The reading was recorded by observing where the bar on the dial was while the viscometer was in motion. The viscosity was then calculated using factor finder provided with the instrument based on the speed at which the viscometer was rotating and the model and number of the spindle used. For example, for a reading on the dial of 25% torque with a spindle #7 at a speed of 10 rpms, the factor finder exhibits a factor of 8,000. The viscosity in cps is calculated by multiplying the factor from the factor finder (8,000) by the % torque (25).

For the vanilla composition, spindle #4 was used at 10 rpm to determine the viscosity. For the mocha composition, spindle #5 was used at 10 rpm. For the caramel composition, spindle #6 was used at 20 rpm.

Moisture measurements were obtained using a Leco TGM800 thermogravimetric analyzer using a loss-on-drying technique and CORNERSTONE analysis software. Mass loss of the sample from an aluminum foil crucible was measured as a function of oven temperature while controlling the atmosphere and ventilation rate in accordance with methods known and used in the art.

As shown in Table 2, each of the compositions had an initial Brix of from about 71.5° Brix to about 74° Brix, and substantially maintained that Brix for at least three months at both 40° F. and 90° F. The pH and density for each of the compositions also maintained substantially the same at initial measurement, 1 month, and 3 months at both 40° F. and 90° F. Table 2 further shows that the aw for each of the compositions was initially below 0.80, and remained below 0.80 until at least 3 months at both 40° F. and 90° F., indicating that the liquid compositions maintained their initial level of antimicrobial effectiveness. The viscosity measurements indicate that, while the viscosity for each of the samples increased over time, all of the samples remained at a viscosity suitable for dispensing via squeeze bottle when stored for an extended period of time.

To further analyze the shelf-stability of the liquid compositions, microbial testing was performed by applying samples of the compositions to PETRIFILM CC, ECC, Y/M, and AC plates. The samples were stored at 90° F. for a period of three months and then transferred to storage at 70° F. for nine additional months. Samples were then removed from the bottles and applied to the plates. Samples applied to the AC plates were prepared in accordance with AOAC method 990.12. Samples applied to the Y/M plates were prepared in accordance with AOAC method 997.02. Samples applied to the CC and ECC plates were prepared in accordance with AOAC method 991.14. Colonies were counted using a 3M PETRIFILM Plate Reader Advanced. The results for the mocha and vanilla compositions at 12 months are provided in Table 3 below.

TABLE 3

| | Mocha | Vanilla |
|---|---|---|
| Coliform (CC plate) | <10 cfu/g | <10 cfu/g |
| E. coli/Coliform (ECC plate) | <10 cfu/g | <10 cfu/g |
| AC plate | <10 cfu/g | <10 cfu/g |
| Yeast and Mold (Y/M plate) | <10 cfu/g | <10 cfu/g |

As shown in Table 3, both the mocha and vanilla compositions exhibited very low levels of microbial growth, showing that the compositions remained shelf-stable for at least 12 months. As the aw level of the liquid composition is expected to be a good indicator of antimicrobial effectiveness, the other samples are expected to exhibit similar microbial growth levels over time when aw is measured below 0.85.

Various embodiments described herein provide liquid compositions for use in lightening, sweetening, and flavoring beverages, such as coffee. The dairy-containing liquid compositions are shelf stable for at least 3 months, including for at least 12 months, when stored at room temperature, and may not require refrigeration even upon opening. Other features and advantages may be obtained depending on the particular embodiment.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

What is claimed is:

1. A shelf stable liquid composition for sweetening, flavoring, and lightening coffee, comprising:
a sweetener system;
a dairy-based lightener system;
flavor;
water;
shortening; and
a second emulsifier component; and
wherein the ingredients are cooked to form a liquid composition that is shelf stable for at least three months at room temperature.

2. The shelf stable liquid composition of claim 1, wherein the dairy-based lightener system comprises 5-13% dairy solids.

3. The shelf stable liquid composition of claim 1, wherein the liquid composition has a pH of from about 6.0 to about 6.5.

4. The shelf stable liquid composition of claim 1, wherein the sweetener system is present in the shelf stable liquid composition in an amount of from about 40.0 wt. % to about 85.0 wt. %, based on a total weight of the shelf stable liquid composition.

5. The shelf stable liquid composition of claim 1, wherein the sweetener system comprises corn syrup, liquid fructose, and granulated sugar.

6. The shelf stable liquid composition of claim 5, wherein the shelf stable liquid composition comprises from about from about 35.0 wt. % to about 45.0 wt. % liquid fructose and from about 20 wt. % to about 25 wt. % granulated sugar.

7. The shelf stable liquid composition of claim 1, wherein the shortening is included in the shelf stable liquid composition in an amount of from about 5 wt. % to about 13 wt. %, based on a total weight of the shelf stable liquid composition.

8. The shelf stable liquid composition of claim 1, wherein the second emulsifier component is included in the shelf stable liquid composition in an amount of less than about 0.2 wt. %, based on a total weight of the shelf stable liquid composition.

9. The shelf stable liquid composition of claim 1, wherein the second emulsifier component comprises lecithin, hydroxylated lecithin, soy lecithin, or combinations thereof.

10. The shelf stable liquid composition of claim 1, further comprising a buffer, salt, an anti-foam agent, a preservative, a polyol, or a combination thereof.

11. The shelf stable liquid composition of claim 1, wherein the shelf stable liquid composition is homogenized but is not subjected to colloidal milling during processing.

12. The shelf stable liquid composition according to claim 1, wherein the shelf stable liquid composition contains less whey protein than dairy-based ingredients.

13. The shelf stable liquid composition according to claim 1, wherein the shelf stable liquid composition has a water activity (aw) of less than 0.85.

14. A shelf stable liquid composition for sweetening, flavoring, and lightening coffee, comprising:
50-60% sugars;
9-13% dairy powder;
10-11% shortening;
flavor;
water; and
a second emulsifier component; and
wherein the ingredients are cooked to form a liquid composition with 15-20% moisture and having a pH of 6.0-6.5 that is shelf stable for at least three months at room temperature.

15. The shelf stable liquid composition of claim 14, wherein the 50-60% sugars comprise 4-10% high maltose corn syrup, 38-43% fructose liquid, and 21-23% granulated cane sugar.

16. The shelf stable liquid composition of claim 14, wherein the shelf stable liquid composition does not contain coffee aroma or coffee.

17. A shelf stable liquid composition for sweetening, flavoring, and lightening coffee, comprising:
50-60% sugars;
6-10% cocoa/chocolate;
5-6% dairy powder;
about 7% shortening;
at least one polyol;
flavor;
water; and
a second emulsifier component; and
wherein the ingredients are cooked to form a liquid composition with 15-20% moisture and having a pH of 6.0-6.5 that is shelf stable for at least three months at room temperature.

18. The shelf stable liquid composition of claim 17, wherein the 50-60% sugars comprise about 3% high maltose corn syrup, 11-13% fructose liquid, and 40-43% granulated cane sugar.

19. The shelf stable liquid composition of claim 17, wherein the shelf stable liquid composition does not contain coffee aroma.

20. The shelf stable liquid composition of claim 17, wherein the shelf stable liquid composition does not contain coffee.
